(19) United States
(12) Patent Application Publication
(10) Pub. No.: US 2002/0002346 A1
(43) Pub. Date: Jan. 3, 2002

(54) Apparatus and method of massaging back and alleviating back pain using suction cup

(76) Inventor: Patricia J. Horst, Rockford, IL (US)

Correspondence Address: LEYDIG VOIT & MAYER, LTD, 6815 WEAVER ROAD, ROCKFORD, IL, 61114-8018, US

(21) Appl. No.: 09/894,754

(22) Filed: Jun. 28, 2001

Related U.S. Application Data
(63) Continuation-in-part of application No. 09/607,035, filed on Jun. 29, 2000.

(51) Int. Cl. A61H 7/00

(52) U.S. Cl. 601/6

(57) ABSTRACT

A pain relieving device that includes a suction cup adapted to be applied to the body of a person. The suction cup is affixed to a handle that allows the suction cup to be manually manipulated by a massager to massage the body of a massagee. The suction cup may be pushed, rolled or pulled to facilitate a massaging effect. The method of using the device includes applying the suction cup to the back of a person and then moving the suction cup to change the suction effect of the suction cup while applied to the back. Additionally, a pump system may be operatively connected to the suction cup to adjust the suction effect. The pump can be controlled to modulate the pressure within the pressure chamber.

### CROSS-REFERENCE TO RELATED PATENT APPLICATIONS

This patent application is a “continuation-in-part,” of copending U.S. patent application Ser. No. 09/607,035, filed Jun. 29, 2000, hereby incorporated by reference it its entirety.

### FIELD OF THE INVENTION

The present invention generally relates to pain relieving devices and more particularly to a pain relieving device that produces a lifting action.

### BACKGROUND OF THE INVENTION

A common aggravation and source of discomfort to many persons is back soreness, back pain, pinched nerves, and muscle fatigue. A common way of alleviating such aggravation and discomfort is through massage. There are a variety of massage techniques and massage devices in existence that are used as remedies to such problems. A drawback with some certain devices or techniques is that they can cause muscle damage or back injury when used improperly. In addition, people respond differently and prefer different forms of massage and massage devices. As such, certain massage techniques and massage devices are not as effective for everyone, and there continues to be a desire for alternatives and/or better forms of massage techniques and pain relieving devices.

### BRIEF SUMMARY OF THE INVENTION

It is a primary objective of the present invention to provide an alternative device and method for relieving bodily pain through a lifting action.

In that regard it is an objective of the present invention to present invention to provide an alternative pain relieving device and technique that is highly effective in alleviating back pain, strained or sore backs, pinched nerves or muscle fatigue.

It is another objective of the present invention to accomplish these previous objectives while ensuring a high degree of safety in the usage of such a pain relieving device.

In accordance with these and other objectives, the present invention is directed towards a pain relieving device that includes a suction cup that is adapted to be applied to the body of a person. The suction cup is affixed to a handle that allows the suction cup to be manually manipulated by a massager to produce a pain relieving effect in the affected area of a massagee. In particular, the suction cup may be pushed, rolled or pulled to facilitate a massaging effect, and preferably a lifting effect.

The present invention is also directed towards a method of using such a pain relieving device. The method includes applying the suction cup to the body of a person and then moving the suction cup to change the suction effect of the suction cup while applied to the body. This massages the body of the person in a manner which has been found to be highly effective. Preferably the suction cup is dipped in warm water or is otherwise heated such that the heat is applied to the affected area of the person.

The present invention is also directed towards a further embodiment of the pain relieving device and a method of using the same. The pain relieving device generally comprises a suction cup for application to a person's body and a pump or vacuum system operatively connected to the suction cup. The suction cup defines an interior pressure chamber between the suction cup and the person's body, while the pump system can adjust the pressure within the pressure chamber, and hence the suction effect. The pain relieving device further includes a handle attached to the suction cup. Preferably, the pump system is operatively connected to the interior pressure chamber via the handle, the handle comprising a hollow tubular member having an interior passage with an inlet connected to the pressure chamber and an outlet connected to the pump.

The method of employing the further embodiment of the pain relieving device is also provided. Generally, the method includes applying the pain relieving device to the body of a person to define a pressure chamber between the suction cup and the body, the suction cup having a suction effect, operating the pump to control the pressure within the pressure chamber and the suction effect of the suction cup; and changing the suction effect of the suction cup while applied to the body to thereby lift or “massage” the affected body area of the person. The step of changing the suction effect can be accomplished, alone or in part, by manipulating the suction cup or by controlling the pump to modulate the pressure within the pressure chamber.

Importantly, the pain relieving device and method provides a lifting action to the back of a person which alleviates pressure on the nerves and muscles. When the suction cup is pulled, lifted or otherwise manipulated, the suction provided thereby provides this lifting action which has been found very effective in alleviating pain. Similarly, control of the pump system can produce similar therapeutic effects. In control, other existing pain relieving devices and techniques work by applying pressure which can cause further problems. Thus, the present invention is superior to such other devices in this and other respects.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective illustration of a pain relieving device according to a preferred embodiment of the present invention being applied to the back of a person.

FIGS. 2-4 are perspective illustrations of the pain relieving device of FIG. 1 being applied to the back of a person according to a preferred method of the present invention.

FIGS. 5-7 illustrate cross sections of the pain relieving device in use and in various positions applying suction to a person's body.

FIG. 8 is a front view of an alternate embodiment of a pain relieving device constructed in accordance with the teachings of the present invention.

FIG. 9 is a cross-sectional view of yet another alternate embodiment of the pain relieving device constructed in accordance with the teachings of the present invention.

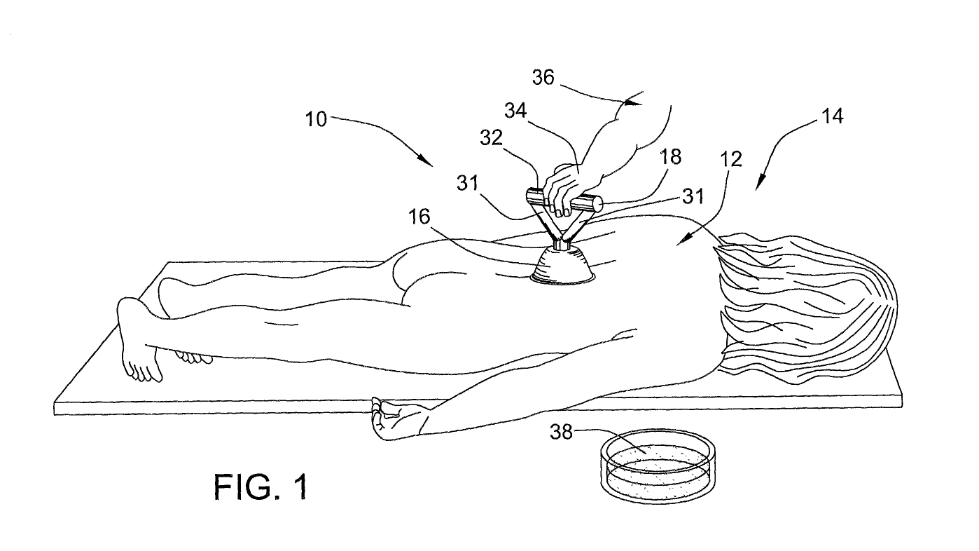

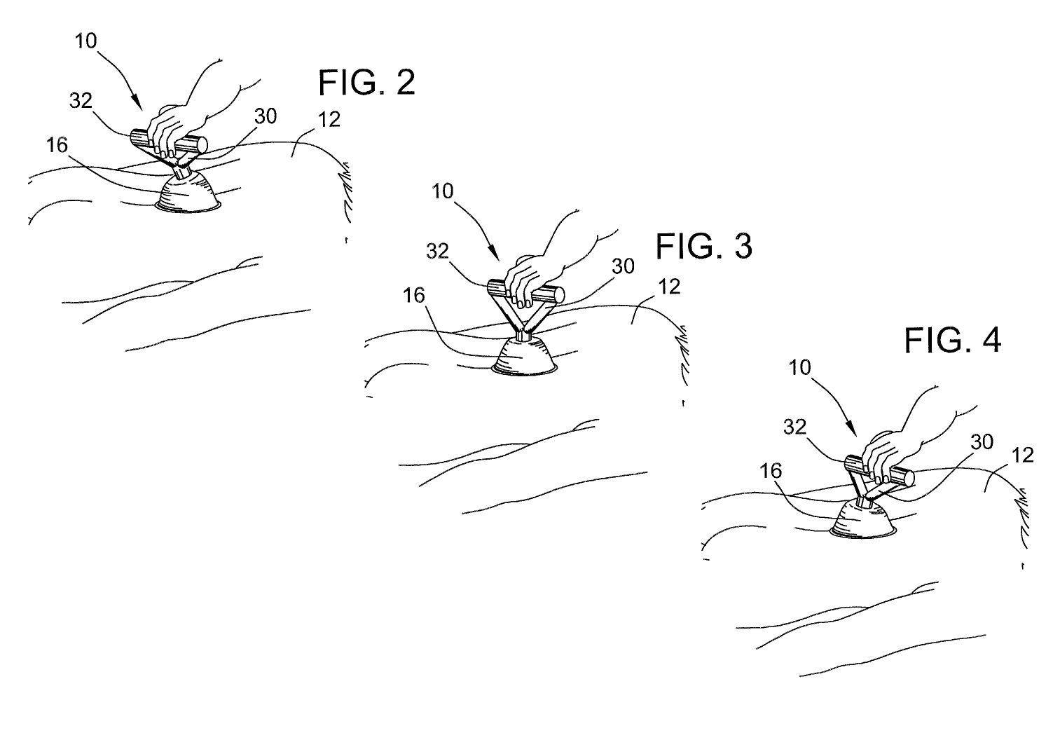

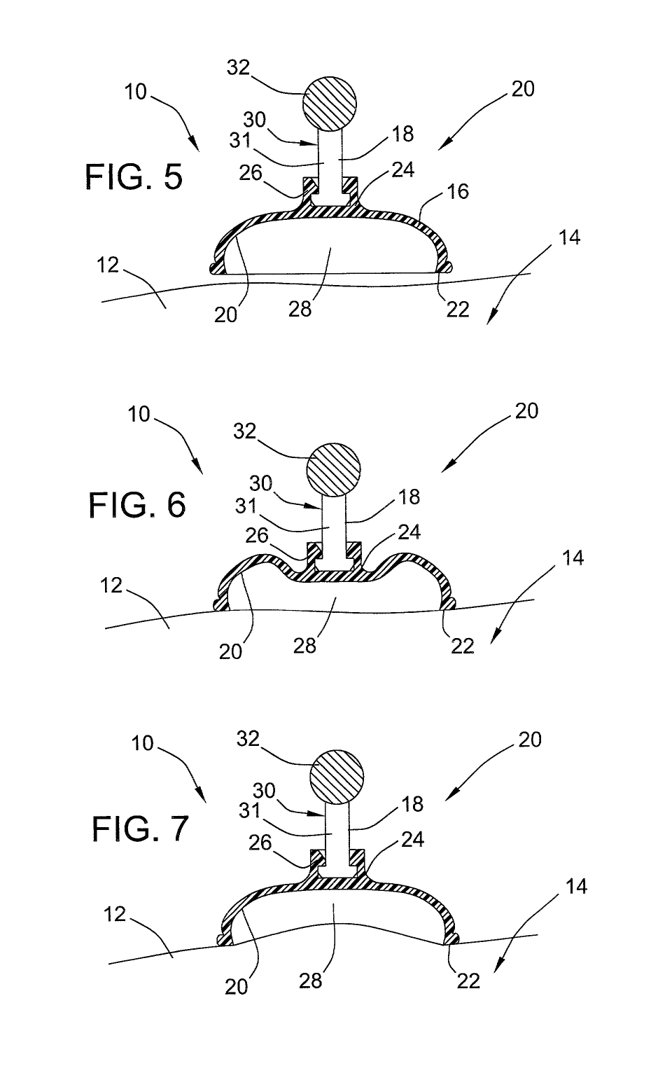

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

For purposes of illustration, a preferred embodiment of the present invention has been depicted as a pain relieving device 10 for massaging the body 12 of a person 14. The back pain relieving device 10 generally includes a suction cup 16 mounted to a handle 18. The suction cup 16 includes a round, flexible, resilient concave disc 20 of either plastic or rubber-like material. The disc is preferably between 4 to 6 inches in maximum diameter, such that one half of a person's back can be worked on at one time, however it will be readily apparent that all sizes of suction cups may be employed in accordance with the teachings of the present invention. It will also be recognized that the pain relieving device can be used on all area's of a person's body, although the figures depicts its use on the back of a person.

The outer peripheral edge 22 of the suction cup 16 is adapted to form a seal against a slightly curved or flat skin surface such as that on the back 12 of the person 14. The suction cup 16 includes a stem portion 26 at the apex 24 of the disc 20 that mounts or is otherwise connected directly to the end of the handle 18 in a removable or permanent manner. The suction cup 16 defines a concave pressure chamber 28 between the apex 24 and the peripheral edge 22. When a seal is formed at the peripheral edge 22 by applying it to the surface of the body 12, the action of pushing, rolling and pulling the suction cup 16 effects a change of pressure in the pressure chamber 28, which in turn massages the back of the person 14. In particular the suction or pressure caused by the suction cup 16 tends to push, pull and move the muscles around which alleviates back discomfort, soreness and back pain.

In the preferred embodiment, the handle 18 includes an axially extending V-shape portion 30 with two V-shaped arms 31 that connects with the stem portion 26 of the suction cup 16 and a transverse hand grip 32 extending in a lateral plane (eg. generally parallel with the plane of the seal formed by the peripheral edge 22). The hand grip 32 is adapted to be manipulated and gripped by the hand 34 of the massager 36. The hand grip 32 allows the massagers 36 to easily push, pull, roll, and rotate the suction cup 16 to facilitate the massaging action. The lateral orientation of the hand grip 32 allows easy manipulation of the device to facilitate this action. The V-shaped arms 31 allow a person to easily grab the grip 32 between arms. It will be appreciated that a T-shaped handle could also be used. The handle 32 is preferably integrally formed such as from plastic material and is sufficiently rigid and certainly more rigid than the suction cup 16 so that it can adequately impart movement in the suction cup to effect body manipulation and pain relief.

Using the massaging device 20 is simple, effective and safe. Safety is achieved because air pressure is being used to effect the massage. According the preferred method of use, the suction cup 16 is first heated, by such means as dipping it in a container of warm water 38. The heat tends to soothe the body 12 as well. Then the suction cup 16 is applied using the handle 18. The hand grip 32 is then manipulated to move the suction cup 16 and more particularly push, pull, rotate, and roll the suction cup 16 to effect pressure changes in the pressure chamber 28 and thereby effect the massage.

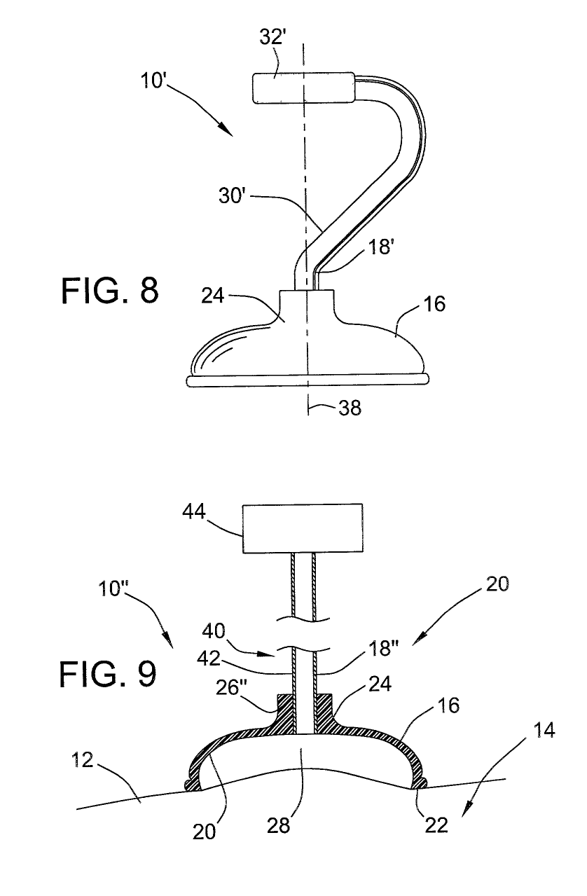

Turning attention to FIG. 8, another embodiment of the pain relieving device 10′ is depicted. Common parts of the pain relieving devices 10′ and 10 have been given common reference numerals. The pain relieving device 10′ generally includes a suction cup 16 mounted to a handle 18′. The suction cup 16 is substantially identical to the suction cup of the prior embodiment. The suction cup 16 again includes a resilient concave disc defining a central axis 38, which in the figure is generally vertically disposed. The handle 18′ in the current embodiment is different, and the alternate handle 18′ has proven very useful in practice for providing effective massage. The handle 18′ is generally an angled L-shaped member, akin to the shape of a question mark. The handle 18′ includes a tubular body 30′ which extends upwardly from the suction cup 16. The tubular body 30′ may be either of hollow or solid construction. The tubular member 30′ includes an angled portion extending upwardly and outwardly from the apex 24, and more specifically extends laterally or radially outward relative to the central axis 38 of the suction cup 16. The tubular member 30′ then includes another bend disposing the free end portion of the tubular member 30′ generally horizontally or laterally. Stated another way, the free end of the tubular member 30′ extends generally perpendicular to the central axis 38. The free end also includes a grip 32′ which is laterally or radially centered above the apex 24 of the suction cup 16 and along the central axis 38. Preferably, the tubular member 30′ is about ⅞“in diameter and positions the grip 32′ approximately 13 inches above the surface to which the suction cup 16 is applied.

Yet another embodiment of the pain relieving device 10” is depicted in FIG. 9. This cross-sectional view is akin to FIG. 7 and depicts a suction cup 16 which has been depicted in a position applied to the surface of the back 12 of a person 14. While similar to the previous embodiments, the current embodiment of the pain relieving device 10′ includes a vacuum or pump system operatively connected to the suction cup 16, and more particularly a pump 44 operatively connected to the pressure chamber 28 within the suction cup 16. The terms pump system and vacuum system (and pump/vacuum) are used interchangeably herein, and refer to systems which are capable of displacing air. It will be recognized that different persons will require different levels of internal pressure, i.e. forming a relative vacuum inside the chamber 28 and generating a suction effect, to effectively manipulate and massage the back 12.

Accordingly, a tube 42 is sealingly connected to the suction cup 16, preferably adjacent the apex 24 via the stem 26″. As the suction cup 16 is constructed of either plastic or rubber-like material, the stem 26″ will adequately seal to the outer surface of the tube 42. However, it will be recognized by those having skill in the art that the inner surface of the stem 26″ may include sealing rings, either integrally formed or separately provided, or other seals, seal mechanisms or deflectable projections which provide a seal between the suction cup 16 and the tube 42. The other end of the tube 42 is properly connected to the pump 44 to provide communication between the pump and the pressure chamber 28 formed between the r suction cup 16 and a person's back 12. The pump/vacuum 44 may either be powered or manually operated.

It will be readily recognized that the tubular member 42 may actually comprise the handle 18″ of the pain relieving device 10″. In this way, all that is needed is a hollow tubular handle 18″ forming an interior passageway, an inlet of which is operatively connected to the pressure chamber 28, while an outlet of the internal passage is operatively connected to a pump 44. A second flexible hose line or tube (not shown) may be connected to the handle 18″, preferably adjacent the free distal end of the handle 18′ proximate the grip 32′, such as in the embodiment of the pain relieving device 10′ depicted in FIG. 8. It will also be readily recognized that the pump 44 may be operatively connected to the pressure chamber 28 directly (and not via the handle), or via a small hose communicating with the pressure chamber 28 at any other position along the suction cup 16. In short, the present invention envisions operatively connecting the pressure chamber 28 to a pump 44, which can be done through the handle 18, or which may be otherwise directly connected. The pump 44 itself may be remotely provided with an additional tubular extension linking the pump 44 and the interior chamber 28 of the suction cup 16, preferably by way of the handle 18″. Alternatively, the pump 44 may be mounted directly to the pain relieving device, preferably to some portion of the handle so as not to disrupt the function of the suction cup.

The method of using the present embodiment of the pain relieving device 10″ is identical in many respects to the methods previously described for the other embodiments of the pain relieving device. However, by way of the pump 44, greater control over the pressure or suction effect within the chamber 28 is now achieved. The pump may operate to modulate the suction effect, which itself may provide some therapeutic effect. For example, certain rhythms or frequencies may prove beneficial for alleviating pain. Pressure sensors and control systems can also be envisioned for finer control over the pressure or suction effect, such as by way of a closed loop feedback system. A pressure sensor can form part of the pump itself, or be individually supplied, preferably fed through the tube connecting the pump and pressure chamber of the suction cup.

The foregoing description of various preferred embodiments of the invention has been presented for purposes of illustration and description. It is not intended to be exhaustive or to limit the invention to the precise forms disclosed. Obvious modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of massaging the body of a person comprising:
providing a pain relieving device comprising a suction cup operatively linked to a pump;
applying the pain relieving device to the body of a person to define a pressure chamber between the suction cup and the body, the suction cup having a suction effect; operating the pump to control the pressure within the pressure chamber and the suction effect of the suction cup; and
changing the suction effect of the suction cup while applied to the body to thereby massage the body of the person.

2. The method of claim 1 wherein the step of changing the suction effect includes manipulating the suction cup to change the suction effect.

3. The method of claim 2 wherein manipulating the suction cup is accomplished using a handle affixed to the suction cup in a cantilever manner.

4. The method of claim 3 wherein manipulating the suction cup includes pushing, pulling and rolling the suction cup using the handle.

5. The method of claim 1 wherein the step of changing the suction effect includes controlling the pump to modulate the pressure within the pressure chamber.

6. The method of claim 1 wherein the pain relieving device further includes a hollow tubular handle attached to the suction cup, the hollow tubular handle defining an interior passage having an inlet connected to the suction cup and an outlet connected to the pump.

7. The method of claim 1 further comprising positioning the suction cup on the back of the body, only one half of the back at a time, the back being divided up into separate halves via the spine, the suction cup being having a diameter of between about 4 inches and about 6 inches.

8. A pain relieving device comprising:
a suction cup for application to a person's body, the suction cup defining an interior pressure chamber between the suction cup and the person's body; and
a pump system operatively connected to the suction cup for adjusting the pressure within the pressure chamber.

9. The pain relieving device of claim 8 further comprising a handle connected to the suction cup.

10. The pain relieving device of claim 9 wherein the handle is attached adjacent an apex of the suction cup.

11. The pain relieving device of claim 9 wherein the pump system is operatively connected to the interior pressure chamber via the handle, the handle comprising a hollow tubular member having an interior passage with an inlet connected to the pressure chamber and an outlet connected to the pump.

12. The method of claim 9 wherein the pump system is mounted to the hollow tubular handle.

13. The pain relieving device of claim 8 further comprising a pressure sensor to detect the pressure within the pressure chamber.

14. The pain relieving device of claim 13 wherein a closed-loop feedback system is formed between the pump, a controller, and the pressure sensor to control the pressure within the pressure chamber.

15. The pain relieving device of claim 8 wherein the suction cup includes a flexible concave disc of rubber-like material.

16. The pain relieving device of claim 15 wherein the flexible concave disc has a diameter between about 4 inches and about 6 inches, such that the flexible concave disc is suitable size for application to one half side of a back of the body of a person.

17. The pain relieving device of claim 9 wherein movement of the suction cup via the handle adjusts the pressure within the pressure chamber.

18. A pain relieving device comprising:
a suction cup having a general concave disc shape, an interior surface of the suction cup defining a pressure chamber, the concave shape of the suction cup defining a central axis extending through an apex of the concave disc shape; and
a handle connected to the suction cup approximate the apex thereof, the handle extending away from the suction cup and defining a grip, the grip being centered over the apex and disposed generally perpendicular to the central axis.

19. The pain relieving device of claim 18 wherein the handle includes an angled L-shaped arm.

20. The pain relieving device of claim 18, wherein the grip is located at least 12 inches from a body surface to which the suction cup is to be applied.
